(19) United States
(12) Patent Application Publication
(10) Pub. No.: US 2014/0009450 A1
(43) Pub. Date: Jan. 9, 2014

(54) Flat Panel Display with Multi-Drop Interface

(71) Applicant: NOVATEK Microelectronics Corp., Hsin-Chu (TW)

(72) Inventors: Chia-Wei Su, Hsinchu City (TW); Shun-Hsun Yang, Hsinchu City (TW); Hsin-Hung Lee, Kaohsiung City (TW); Po-Hsiang Fang, Hsinchu City (TW); Po-Yu Tseng, Taoyuan County (TW); Li-Tang Lin, Hsinchu City (TW)

(21) Appl. No.: 13/935,546

(22) Filed: Jul. 4, 2013

(30) Foreign Application Priority Data
Jul. 5, 2012 (TW) 101124210

(51) Int. Cl. G09G 5/00

(52) U.S. Cl. CPC G09G 5/001
USPC 345/204

(57) ABSTRACT

A flat panel display with multi-drop interfaces is disclosed. The flat panel display with multi-drop interfaces includes a plurality of driver chips having a plurality of respective hardware setting values via a hardware setting, and a timing controller for transmitting at least one signal to the plurality of driver chips via at least one multi-drop interface, wherein the timing controller and a specific driver chip among the plurality of driver chips negotiate with each other according to a corresponding specific respective hardware setting value among the plurality of respective hardware setting values.

### BACKGROUND OF THE INVENTION

1. Field of the Invention

The present invention relates to a flat panel display with multi-drop interfaces, and more particularly, to a flat panel display with multi-drop interfaces capable of configuring different driver chips with different hardware setting values by hardware setting, such that a timing controller and each driver chip can negotiate with each other for adjustment, to achieve more flexible application.

2. Description of the Prior Art

With higher resolution and more gray scale of a liquid crystal display device, data transmission between a timing controller and driver chips (source driver) in a panel driving device increases rapidly, which causes problems such as large circuit area, high power consumption and high electromagnetic interference, etc. Thus, the industry has developed a multi-drop interface to solve the above problems about circuit area, power consumption, etc.

Please refer to FIG. 1A to FIG. 1D, which are schematic diagrams of conventional flat panel displays with multi-drop interfaces 10, 12, 14, and 16. As shown in FIG. 1A to FIG. 1D, in each of the flat panel displays with multi-drop interfaces 10, 12, 14, and 16, a timing controller 100 transmits at least one driving signal (e.g. same image signal, latch-up data signal, polarity control signal, etc.) to a plurality of driver chips (e.g. driver chips DIC₁-DIC₁₈) via at least one multi-drop interface, such that the plurality of driver chips can drive pixels of corresponding data line accordingly. Though the flat panel displays with multi-drop interfaces 10, 12, 14, and 16 in FIG. 1A to FIG. 1D have different structures, the operations of the timing controller 100, which transmits at least one driving signal via the at least one multi-drop interface, are similar, and hence the timing controllers are denoted by the same symbol (only the timing controller 100 in the flat panel display with multi-drop interfaces 14 transmits the at least one driving signal via multi-drop interfaces and further transmits signals via point-to-point interfaces).

In such a condition, since the timing controller 100 broadcasts and transmits the driving signal to all driver chips via the multi-drop interfaces, and can not adjust the driving signal or internal setting of each driver chip for driving control according to status of each driver chip, operations for the timing controller 100 to control the driver chips are limited.

For example, a driver chip farther from the timing controller 100 (e.g. the driver chip DIC₁ of the flat panel display with multi-drop interface 10) may not recognize the received driving signal since eye diagram of the received driving signal is too worse. At this moment, since all the driver chips are the same for the timing controller 100 and can not be adjusted separately, abnormal image may display. Thus, there is a need for improvement of the prior art.

### SUMMARY OF THE INVENTION

It is therefore an objective of the present invention to provide a flat panel display with multi-drop interfaces capable of configuring different driver chips with different hardware setting values by hardware setting, such that a timing controller and each driver chip can negotiate with each other for adjustment, to achieve more flexible application.

The present invention discloses a flat panel display with multi-drop interfaces. The flat panel display with multi-drop interfaces comprises a plurality of driver integrated chips (ICs) having a plurality of respective hardware setting values via a hardware setting, and a timing controller for transmitting at least one signal to the plurality of driver integrated chips via at least one multi-drop interface, wherein the timing controller and a specific driver integrated chip among the plurality of driver integrated chips negotiate with each other according to a corresponding specific respective hardware setting value among the plurality of respective hardware setting values.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1A to FIG. 1D are schematic diagrams of conventional four types of flat panel displays with multi-drop interfaces.

FIG. 2A is a schematic diagram of a flat panel display with multi-drop interfaces according to an embodiment of the present invention.

FIG. 2B to FIG. 2E are schematic diagrams of five types of flat panel displays with multi-drop interfaces according to an embodiment of the present invention.

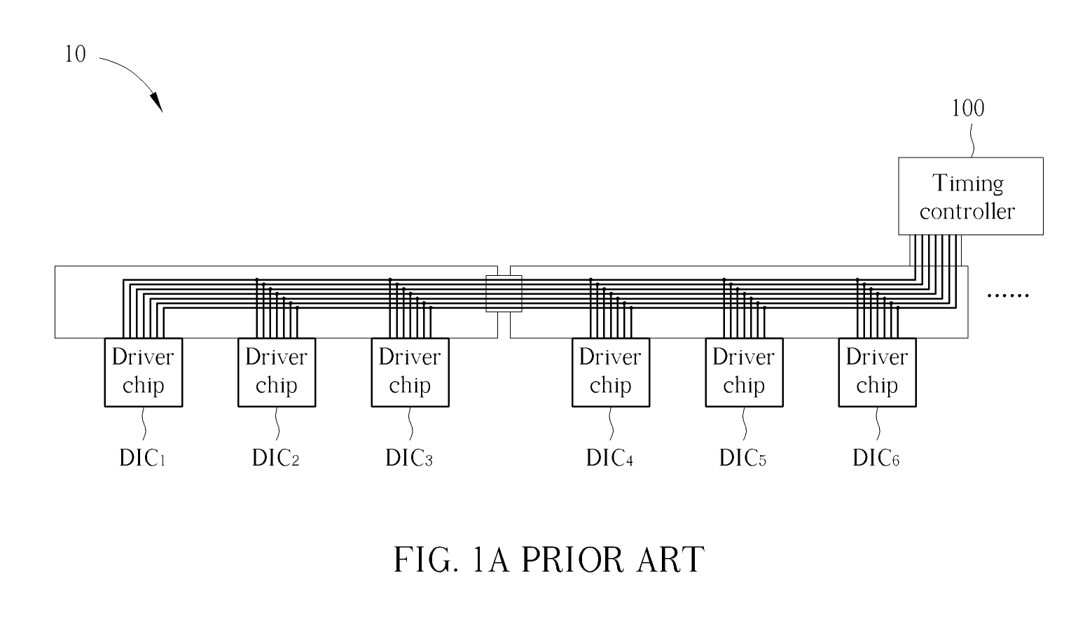

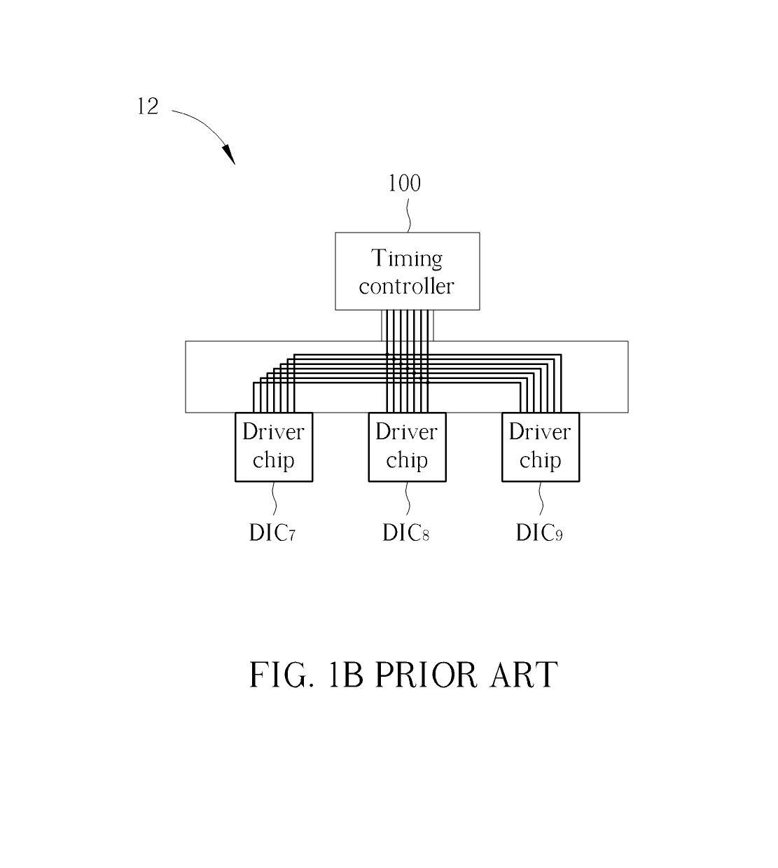

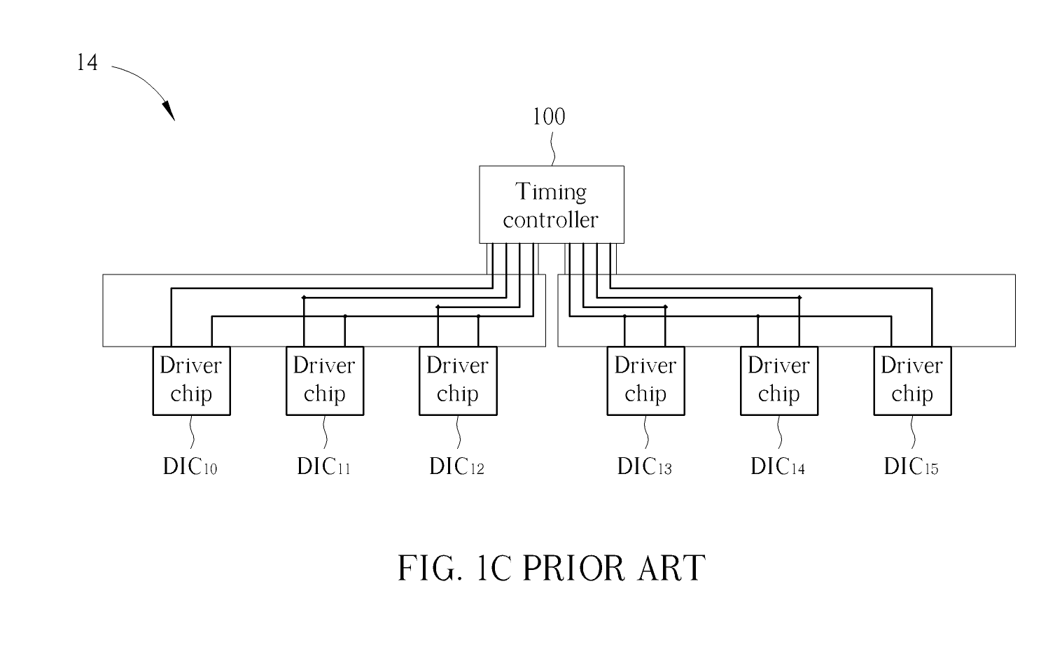

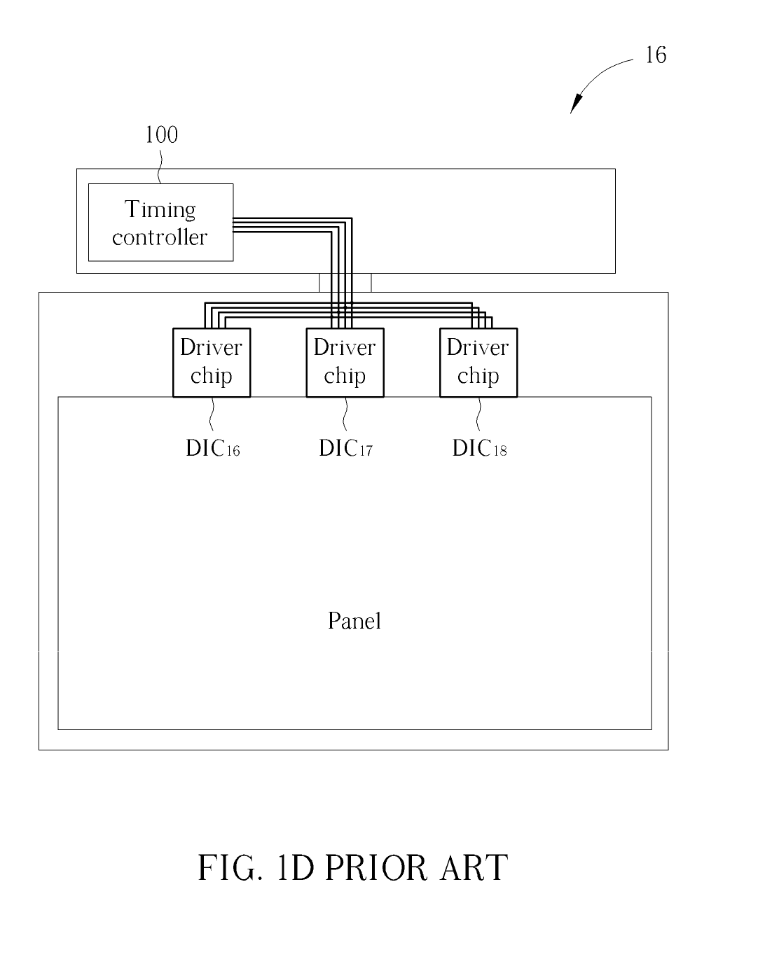

### DETAILED DESCRIPTION

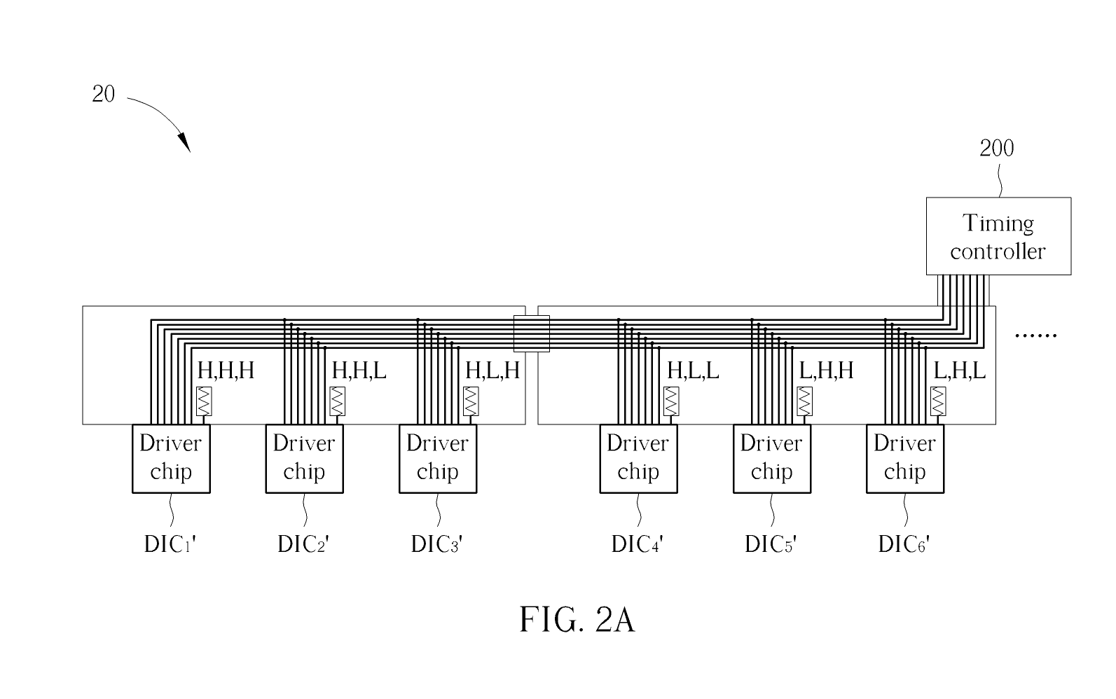

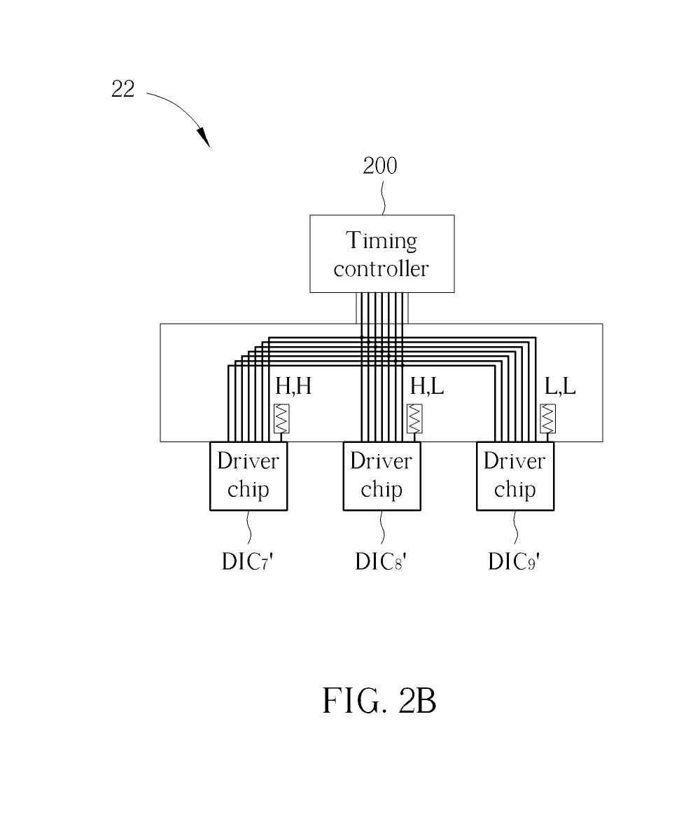

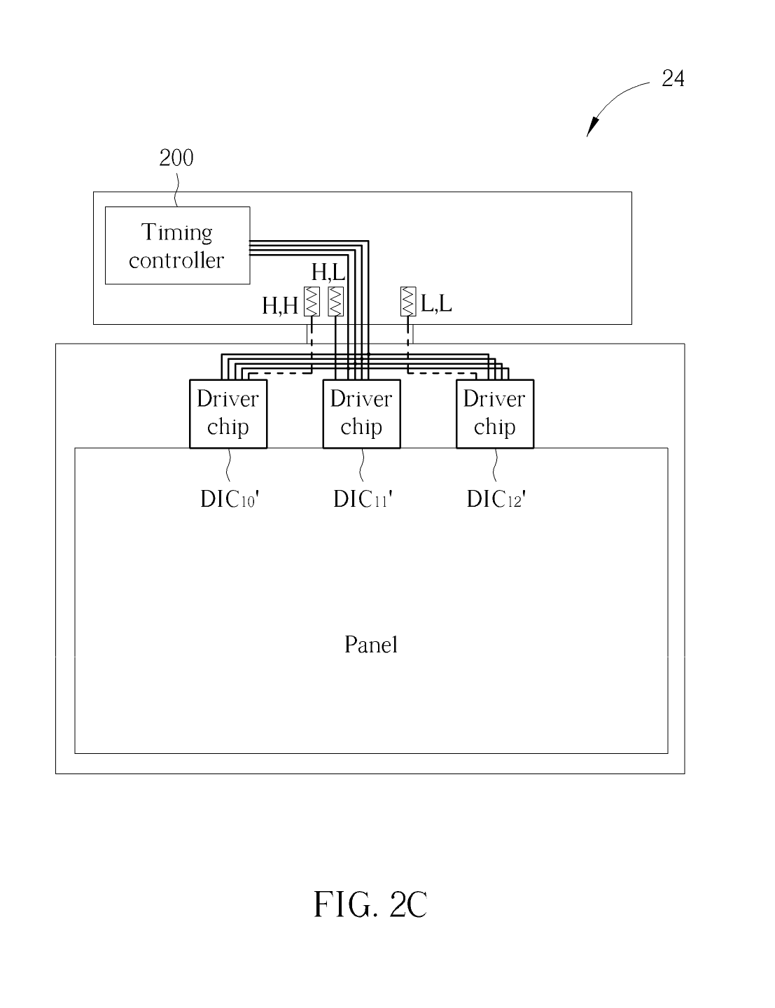

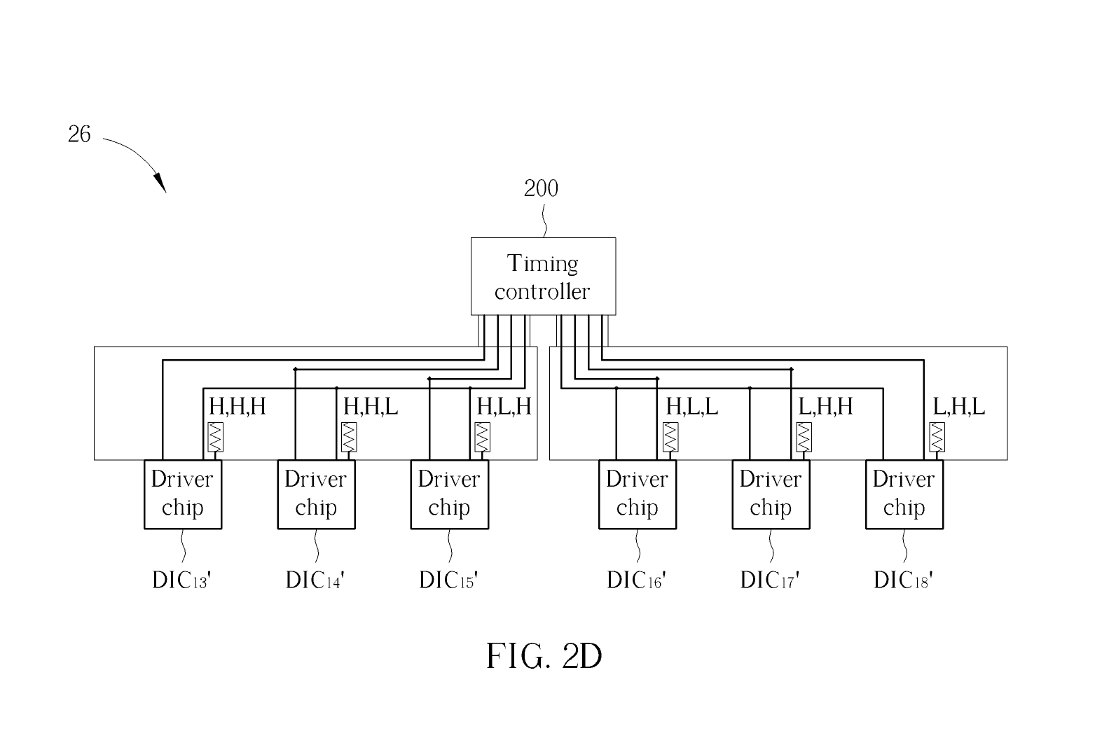

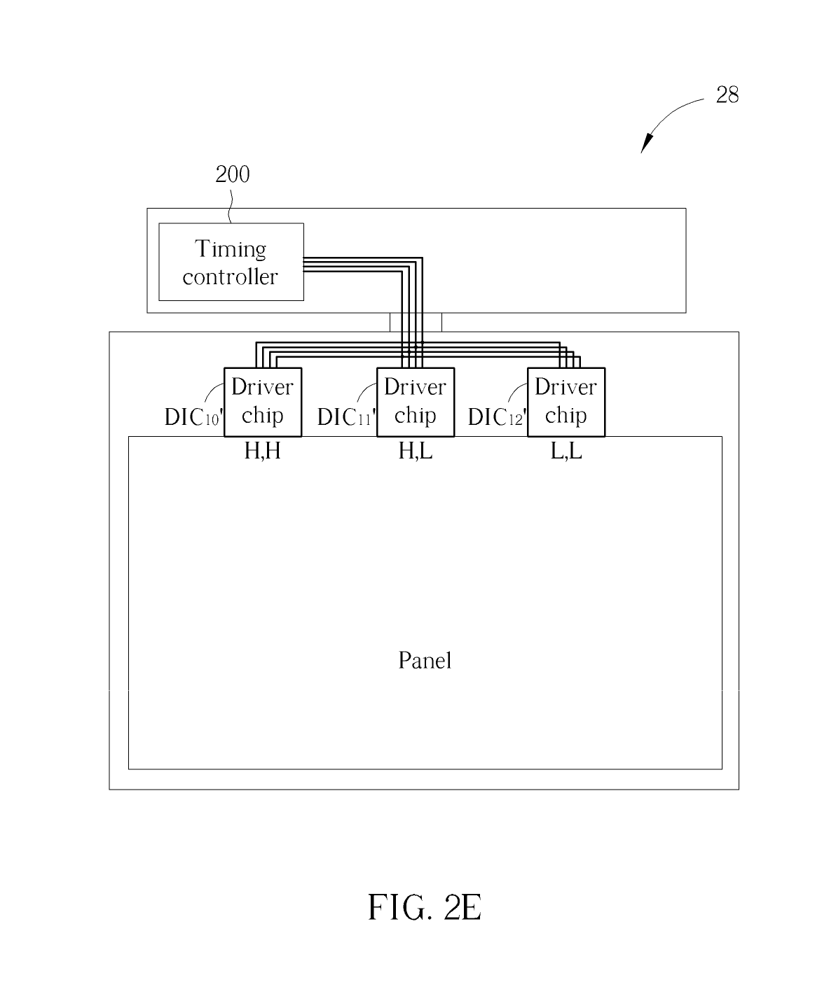

Please refer to FIG. 2A, which is a schematic diagram of a flat panel display with multi-drop interfaces 20 according to an embodiment of the present invention. As shown in FIG. 2A, the flat panel display with multi-drop interfaces 20 includes a timing controller 200 and driver chips DIC₁′-DIC₆′. The driver chips DIC₁′-DIC₆′ have respective hardware setting values HSV₁-HSV₆ via a hardware setting. The timing controller 200 transmits at least one signal (e.g. driving signal such as image signal, latch-up data signal, polarity control signal, etc. or control signal) to the driver chips DIC₁′-DIC₆′ via at least one multi-drop interface, wherein the timing controller 200 and a specific driver chip DICₓ′ among the driver chips DIC₁′-DIC₆′ can negotiate with each other according to a corresponding specific respective hardware setting value HSVₓ (the specific driver chip DICₓ′ can be any one of the driver chips DIC₁′-DIC₆′). In such a situation, the timing controller 200 can control the specific driver chip DICₓ′ individually, and the specific driver chip DICₓ′ can reply a receiving status of receiving the at least one signal via the at least one multi-drop interface to the timing controller 200, such that the timing controller 200 and the specific driver chip DICₓ′ can adjust operation accordingly. As a result, the present invention can configure different driver chips DIC₁′-DIC₆′ with different respective hardware setting values HSV₁-HSV₆ by hardware setting, such that the timing controller 200 and each driver chip can negotiate with each other for adjustment, to achieve more flexible application.

In detail, the timing controller 200 can add the specific respective hardware setting value HSVₓ in the signal intended to be transmitted to the specific driver chip DICₓ′, to indicate the signal having the specific respective hardware setting value HSVₓ is provided for the specific driver chip DICₓ. Therefore, though the timing controller 200 transmits the signal having the specific respective hardware setting value HSVₓ to all of the driver chips DIC₁′-DIC₆′ via multi-drop interfaces, only the specific driver chip DICₓ may perform driving or adjustment according to the signal having the specific respective hardware setting value HSVₓ, and other driver chips may ignore the signal having the specific respective hardware setting value HSVₓ. In such a situation, since the timing controller 200 can acknowledge the status of the specific driver chip DICₓ according to the specific respective hardware setting value HSVₓ, when transmitting signals, the timing controller 200 can control and adjust according to the requirement of the specific driver chip DICₓ properly.

For example, if the timing controller 200 acknowledges that the specific driver chip DICₓ having the specific respective hardware setting value HSVₓ has abnormal working status or needs to adjust the corresponding display image, the timing controller 200 can transmit the control signal having the specific respective hardware setting value HSVₓ for performing proper adjustment to the driver chips DICₓ. For example, the timing controller 200 knows that a chip corresponding to the driver chip DIC₁ having the respective hardware setting value HSV₁ is farthest, and thus can transmit the control signal having the respective hardware setting value HSV₁ to adjust setting of the driver chip DIC₁ such that the driver chip DIC₁ can receive follow-up driving signals normally. As a result, the timing controller 200 can control the specific driver chip DICₓ′ individually.

On the other hand, when the timing controller 200 transmits a driving signal without any respective hardware setting value to all of the driver chips DIC₁′-DIC₆′, the specific driver chip DICₓ can reply a receiving status of receiving the driving signal and the specific respective hardware setting value HSVₓ to the timing controller 200. In such a situation, when determining a problem occurs in the receiving signal, the specific driver chip DICₓ can notify the timing controller 200 to perform adjustment, such that the timing controller 200 acknowledges the receiving status and then adjusts the driving signal accordingly, or transmits the control signal having the specific respective hardware setting value HSVₓ to adjust the specific driver chip DICₓ. As a result, the specific driver chip DICₓ′ can reply a receiving status of receiving signal via multi-drop interfaces to the timing controller 200, such that the timing controller 200 and the specific driver chip DICₓ can adjust operation accordingly for the specific driver chip DICₓ′ to receive signal accurately.

For example, when the specific driver chip DICₓ informs the timing controller 200 that the driving signal is too weak and thus can not be received accurately, the timing controller 200 can strengthen the driving signal transmitting to all of the driver chips DIC₁′-DIC₆′ according to a chip location corresponding to the respective hardware setting value HSVₓ (i.e. strengthen the driving signal according to the location of the driver chip which can not receive accurately, such that all of the driver chips can receive accurately), or strengthen the driving signal and add the respective hardware setting value HSVₓ according to a chip location corresponding to the respective hardware setting value HSVₓ, to indicate the strengthened driving signal is provided for the specific driver chip DICₓ, such that the specific driver chip DICₓ can receive signal accurately. On the other hand, when the specific driver chip DICₓ informs the timing controller 200 that the specific driver chip DICₓ can not receive the driving signal accurately due to internal setting (e.g. the bandwidth setting is too low), the timing controller 200 adjusts internal setting of the specific driver chip DIC_{K} according to the respective hardware setting value HSVₓ, or the specific driver chip DICₓ adjusts internal setting by itself (the timing controller 200 stops transmitting signal at this moment).

Besides, in the flat panel display with multi-drop interfaces 20, the implementation of hardware setting is to set different resistor configurations to at least one respective pin corresponding to the driver chips DIC₁′-DIC₆′ on printed circuit board (PCB), such that the driver chips DIC₁′-DIC₆′ have the respective hardware setting values HSV₁-HSV₆. In detail, each of the driver chips DIC₁′-DIC₆′ has three respective pins, wherein a pin configured with a resistor is high (H) and a pin configured without a resistor is low (L), and hence the respective hardware setting values HSV₁-HSV₆ of the driver chips DIC₁′-DIC₆′ are (H, H, H), (H, H, L), (H, L, H), (H, L, L), ( L, H, H), (L, H, L). As a result, the present invention can set different resistor configurations to different driver chips DIC₁′-DIC₆′, such that the different driver chips DIC₁′-DIC₆′ have different respective hardware setting values HSV₁-HSV₆.

Noticeably, the spirit of the present invention is to configure different driver chips DIC₁′-DIC₆′ with different respective hardware setting values HSV₁-HSV₆ by hardware setting, such that the timing controller 200 and each driver chip can negotiate with each other for adjustment, to achieve more flexible application. Those skilled in the art can make modifications or alterations accordingly. For example, the quantity of multi-drop interfaces, transmitted signals, driver chips, and respective pins corresponding to a driver chip, whether the timing controller 200 and the driver chips DIC_{T}′-DIC₆′ are on different PCBs, and structure of flat panel displays with multi-drop interfaces, etc. are not limited to the embodiment illustrated in FIG. 2A, and can be the flat panel displays with multi-drop interfaces 22, 24, and 26 with other numbers and different structures as shown in FIG. 2B to FIG. 2D, as long as different driver chips are configured with different respective hardware setting values by hardware setting (driver chips DIC₇′-DIC₉′ have different respective hardware setting values, driver chips DIC₁₀′-DIC₁₂′ have different respective hardware setting values, and driver chips DIC₁₃′-DIC₁₈′ have different respective hardware setting values), such that the timing controller 200 and each driver chip can negotiate with each other for adjustment. The operation of the timing controller 200 in the flat panel displays with multi-drop interfaces 20, 22, 24, and 26 are similar and hence denoted by the same symbol (only the timing controller 200 in the flat panel display with multi-drop interfaces 26 transmits the at least one signal via multi-drop interfaces and further transmits signals via point-to-point interfaces).

Besides, in the above embodiment, the implementation of hardware setting is to set different resistor configurations to respective pins corresponding to the driver chips on PCB, such that the driver chips have respective hardware setting values. However, in other embodiments, hardware setting can also be implemented with other methods, such that the driver chips have respective hardware setting values. For example, please refer to FIG. 2E, which is a schematic diagram of a further flat panel display with multi-drop interfaces 28 according to an embodiment of the present invention. The flat panel display with multi-drop interfaces 28 is substantially similar to the flat panel display with multi-drop interface 24, and hence elements and signals with similar functions are denoted by the same symbols. The main difference between the flat panel display with multi-drop interfaces 28 and the flat panel display with multi-drop interfaces 24 is that the implementation of hardware setting in the flat panel display with multi-drop interfaces 28 is to set the respective hardware setting values at respective locations of glass corresponding to the driver chips DIC₁₀′-DIC₁₂′. In such a situation, high/low level can be set directly on glasses, and hence configurations of additional resistors are not required.

In addition, the implementation of hardware setting can also be burning different respective hardware setting values into different driver chips, e.g. by utilizing a one time programmable (OTP) technique, burning different respective hardware setting values into different driver chips under chip test or by the timing controller 200. Moreover, the implementation of hardware setting can also be directly predefining different respective hardware setting values as default values inside different driver chips.

In the prior art, since the timing controller 100 broadcasts and transmits the driving signal to all driver chips via the multi-drop interfaces, and can not adjust the driving signal or internal setting of each driver chip for driving control according to status of each driver chip, operations for the timing controller 100 to control the driver chips are limited. In comparison, the present invention can configure different driver chips DIC₁′-DIC₆′ with different respective hardware setting values HSV₁-HSV₆ by hardware setting, such that the timing controller 200 and each driver chip can negotiate with each other for adjustment, to achieve flexible application.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A flat panel display with multi-drop interfaces, comprising:
a plurality of driver chips, having a plurality of respective hardware setting values via a hardware setting; and
a timing controller, for transmitting at least one signal to the plurality of driver chips via at least one multi-drop interface;
wherein the timing controller and a specific driver chip among the plurality of driver chips negotiate with each other according to a corresponding specific respective hardware setting value among the plurality of respective hardware setting values.

2. The flat panel display with multi-drop interfaces of claim 1, wherein the timing controller adds the specific respective hardware setting value in the at least one signal, to indicate the at least one signal is provided for the specific driver chip.

3. The flat panel display with multi-drop interfaces of claim 1, wherein the specific driver chip replies a receiving status of receiving the at least one signal and the specific respective hardware setting value to the timing controller, and the timing controller adjusts the at least one signal accordingly.

4. The flat panel display with multi-drop interfaces of claim 3, wherein when the receiving status indicates the at least one signal is too weak to be received accurately, the timing controller strengthens the at least one signal according to a chip location corresponding to the specific respective hardware setting value.

5. The flat panel display with multi-drop interfaces of claim 4, wherein the timing controller adds the specific respective hardware setting value in the at least one signal, to indicate the at least one strengthened signal is provided for the specific driver chip.

6. The flat panel display with multi-drop interfaces of claim 3, wherein when the receiving status indicates the specific driver chip can not receive the at least one signal accurately due to an internal setting, the timing controller adjusts the internal setting of the specific driver chip according to the specific respective hardware setting value.

7. The flat panel display with multi-drop interfaces of claim 3, wherein when the receiving status indicates the specific driver chip can not receive the at least one signal accurately due to an internal setting, the specific driver chip adjusts the internal setting by itself.

8. The flat panel display with multi-drop interfaces of claim 1, wherein the hardware setting is to set different resistor configurations to a plurality of respective pins corresponding to the plurality of driver chips, such that the plurality of driver chips have the plurality of respective hardware setting values.

9. The flat panel display with multi-drop interfaces of claim 1, wherein the hardware setting is to set the plurality of respective hardware setting values at a plurality of glass locations corresponding to the plurality of driver chips.

10. The flat panel display with multi-drop interfaces of claim 1, wherein the hardware setting is to burn the plurality of respective hardware setting values into the plurality of driver chips.

11. The flat panel display with multi-drop interfaces of claim 1, wherein the hardware setting is to predefine the plurality of respective hardware setting values as default values inside the plurality of driver chips.
